(19) United States
(12) Patent Application Publication
(10) Pub. No.: US 2002/0130649 A1
(43) Pub. Date: Sep. 19, 2002

(54) Frequency converter system having a damper device with a general complex impedance for damping undesirable resonant oscillations in a tuned circuit formed by at least one input-side inductance and parasitic distributed capacitances

(76) Inventors: Sebastian Raith, Erlangen (DE); Bernd Segger, Erlangen (DE)

Correspondence Address: BAKER & BOTTS, 30 ROCKEFELLER PLAZA, NEW YORK, NY, 10112

(21) Appl. No.: 09/918,006

(22) Filed: Jul. 30, 2001

(30) Foreign Application Priority Data
Dec. 22, 2000 (DE) 100 642 12.8

(51) Int. Cl. H01F 17/00

(52) U.S. Cl. 323/355

(57) ABSTRACT

The invention relates to a frequency converter system having a filter, an input-side inductance, in particular a mains system input inductor, and a converter with an input converter and an inverter for operation of an electrical machine, having a tuned circuit which is formed by at least one input-side inductance and parasitic distributed capacitances in the frequency converter system with undesirable resonant oscillations during operation of the frequency converter system, with a damping device being provided for damping the tuned circuit.

### BACKGROUND OF THE INVENTION

In present-day frequency converter systems having a intermediate voltage circuit, in particular multi-shaft converter systems, system oscillations can form which are virtually undamped. This relates essentially to converters having an intermediate voltage circuit and a controlled feed in the form of a regulated mains-system-side converter, which is also referred to as an input converter.

In principle, converters are used to operate electrical machines from a variable supply frequency. Such an intermediate circuit frequency converter makes it possible to operate an electrical motor, for example a three-phase motor such as a synchronous motor, no longer just directly from the mains system linked to an inflexible rotation speed, but by a mains system having frequency and amplitude which are both variable, and which are produced electronically, for supplying the motor.

The two mains systems are the supply mains system whose amplitude and frequency are fixed, and the mains system used to supply the electrical machine with a variable amplitude and frequency. The two mains systems are decoupled via a DC voltage store or direct-current store in the form of what is referred to as an intermediate circuit. Such intermediate circuit converters essentially have three central assemblies:

a mains-system-side input converter, which may be designed to be uncontrolled (for example diode bridges) or controlled, and in which case energy can be fed back into the mains system only when using a controlled input converter;

an energy store in the intermediate circuit in the form of a capacitor for a voltage intermediate circuit or an inductor for a current intermediate circuit; and

an output-side machine converter or inverter for supplying the motor, which generally converts the DC voltage of a voltage intermediate circuit to a three-phase voltage system via a three- phase bridge circuit having six active current devices, for example IGBT transistors, which can be turned off.

Such a frequency converter system (converter system) is preferably used, inter alia, for main and servodrives in machine tools, robots and production machines since it has a very wide frequency and amplitude control range. Such a converter system is shown schematically in FIG. 1 and by way of background discussed below. The converter UR in this converter system is connected to a three-phase mains system N having three mains-system phases L₁, L₂ and L₃ via a filter F and an input-side inductance, specifically a mains system input inductor L_{K} (energy-storage inductor). The converter UR has the input converter E (feed), a voltage intermediate circuit with the energy-storage capacitance C_{ZK}, and an output inverter W.

The converter system shown in FIG. 1 further shows a regulated input converter E, which is regulated by switching components (for example a three-phase bridge circuit comprising IGBT transistors), so that the arrangement receives a stimulus A1. The inverter W is likewise regulated by further switching components, for example, by means of a three-phase bridge circuit having six IGBT transistors. The fact that switching operations also take place in the inverter likewise represents a stimulus A2 to the system. The capacitor C_{ZK} in the intermediate voltage circuit is connected between the positive intermediate circuit rail P600 and the negative intermediate circuit rail M600. On the output side, the inverter is connected to a motor M, in the form of a three-phase machine, via a line LT having a protective-ground conductor PE and a shield SM.

By means of a regulated feed via the filter F and the mains input inductor Lₖ, the fixed-frequency three-phase mains system N now feeds the intermediate circuit capacitor C_{ZK} via the input converter E, with the input converter E (for example a pulse-controlled converter) operating with the energy-storage inductor Lₖ as a step-up converter. Once current has been passed to the mains system input inductor L_{K}, it is connected to the intermediate circuit and forces the current against the higher voltage into the capacitor C_{ZK}. This means that the intermediate voltage circuit may be even greater than the peak value of the mains system voltage. This combination thus effectively represents a DC voltage source. The inverter W uses this DC voltage in the manner described to form a three-phase voltage system with the output voltage not having the profile of an ideal sinusoidal oscillation, also having added harmonics in contrast to the sinusoidal voltage from a three-phase generator, since it is produced electronically via a bridge circuit. However, in addition to the described components in the aforesaid converter systems, it must also be remembered that parasitic capacitances occur which assist in the formation of system oscillations in a converter system such as this. For example, in addition to the filter F having a discharge capacitance C_{F}, the input converter E, the inverter W and the motor M also have discharge capacitances C_{E}, C_{W} and C_{M} to earth. Furthermore, there is also a capacitance C_{PE} from the line LT to the protective-ground conductor PE, and a capacitance C_{SM} from the line LT to the grounded shield SM.

These system oscillations are stimulated in a particularly pronounced manner in the feed E. Depending on the control method chosen for the feed, two or three phases of the mains system N are in this case short-circuited, in order to pass current to the energy-storage inductor Lₖ. If all three phases U, V and W are short-circuited, then either the positive intermediate circuit rail P600 or the negative intermediate circuit rail M600 is locked to the star point of the supplying mains system (generally close to ground potential depending on the zero system component). If two phases of the mains system N are short-circuited, then the relevant intermediate circuit rails P600 and M600 are locked to an inductive voltage divider between the two mains system phases.

Depending on the mains system voltage situation, the voltage is close to ground potential (approximately 50-60 V). Since the intermediate circuit capacitance C_{ZK} is generally high (continuous voltage profile), the other intermediate circuit rail is 600 V lower or higher, and can thus also break down the remaining phase of the mains system. In both situations, the intermediate circuit is severely deflected from its “natural” balanced rest position (+/−300 V with respect to earth) and results in a particularly strong stimulus for system oscillation. With regard to the formation of undesirable system oscillations, the frequency range below 50 to 100 kHz, which is relevant for this application area, allows a resonant frequency to be calculated with concentrated elements. In this case, the discharge capacitances C_{F} to ground in the filter F are generally sufficiently large that they do not govern the frequency.

The resonant frequency fᵣₑₛ(sys) of this system, which is referred to as fᵣₑₘ in the following text, is thus given by the formula:

$${f}_{sys} = \frac{1}{2 π \sqrt{{L}_{\sum } {C}_{\sum }}} ,$$

where

L_{Σ}=L_{K}+L_{F},

and where Lₖ represents the dominant component and L_{F} the unbalanced inductive elements acting on the converter side in the filter (for example current-compensated inductors), and

C_{Σ}=C_{E}+C_{W}+C_{PE}+C_{SM}+C_{M}

This relationship is shown schematically in FIG. 2. In this case, L_{Σ} and C_{Σ} form a passive circuit, which is stimulated by a stimulus A and starts to oscillate at its natural resonant frequency f_{sys}. In consequence, the potentials on the intermediate circuit rails P600 and M600 are modulated with an additional undesirable resonant oscillation with an amplitude of up to several hundred volts in addition to the shifts, with an amplitude of 600 V for example, resulting from operation.

These undesirable resonant oscillations have a number of undesirable effects on the frequency converter system. Any unbalanced current which occurs produces losses when it flows through the mains system input inductor Lₖ, thus resulting in an undesirable and considerable increase in the temperature of the mains system input inductor Lₖ. The undesirable resonant oscillation deflects the intermediate circuit considerably further from its central rest position than was caused by the switching operations of the input converter E itself. This can endanger the insulation in the motor M.

The poor damping in the resonant tuned circuit above all results in high unbalanced peak current values, which can lead to saturation of the magnetic components in the filter F.

### SUMMARY OF THE INVENTION

The present invention is the design of a frequency converter system having a tuned circuit which is formed by at least one input-side inductance and parasitic distributed capacitances in the frequency converter system wherein any undesirable resonant oscillations are damped. According to the present invention, the frequency converter system has a damping device for damping the tuned circuit together with the undesirable system oscillations. The damping device comprises a damping element and a connecting element, particularly for transformer coupling of the damping element (by analogy with the principle of current-compensated inductors) to the frequency converter system.

In the broadest sense of the invention, a general complex impedance is used as the damping element. In a preferred embodiment, the damping element is in the form of a passive, solid-state impedance, and, in particular, in the form of a non-reactive resistor for transformer coupling to the frequency converter system.

Another advantageous embodiment of the present invention, the connecting element can be connected to the input-side inductance, or integrated in it.

Reference is made to the Patent Application from SIEMENS AG “Frequenzumrichtersystem mit einer Dämpfungseinrichtung mit einer passiven, statischen Impedanz zur Bedämpfung unerwünschter Resonanz-schwingungen in einem durch mindestens eine eingangsseitige Induktivität und parasitäre verteilte Kapazitaten gebildeten Schwingkreis” [Frequency converter system having a damping device with a passive, solid-state impedance for damping undesirable resonant oscillations in a tuned circuit formed by at least one input-side inductance and parasitic distributed capacitances] (internal reference: 200017852), whose entire disclosure content is expressly included in this Patent Application.

In yet another advantageous embodiment of the present invention, the damping element is transformed via a connecting element between the converter side of the filter and the feed. In a further preferred embodiment, a connecting element can be provided which is used for coupling the damping element in the intermediate circuit as close as possible to the input-side inductance. The connecting element may be in the form of a separate current transformer (for example a toroidal-core transformer).

The damping element may also be in the form of a passive, variable impedance, in particular a PTC thermistor (cold thermistor) for transformer coupling to the frequency converter system. The positive temperature coefficient of the PTC thermistor means that the resistance rises with temperature, resulting in positive feedback of the damping effect. When the frequency converter system is started up, the amount of heating is low, and the amount of damping is thus also low.

When a high-amplitude natural system oscillation occurs in the frequency converter system, a large current is transformed into the damping circuit, thus heating the PTC thermistor and hence increasing the damping effect. The increased damping decreases the amplitude of the natural oscillation of the frequency converter system, thus preventing any further current rise and hence not heating-up the PTC thermistor any more. The thermal system formed by the PTC thermistor and the associated heat sink is used to influence, and hence control, the time constant of this oscillation initiation behavior of the PTC thermistor when the frequency converter system is started up.

In a further preferred embodiment of the present invention, the damping element is in the form of an active, variable impedance, specifically an electronic resistance for transformer coupling to the frequency converter system. Such an active solution with an electronic resistance results in very high efficiency and the resultant heat losses are only small. An electronic resistance may be variable via appropriate hardware or software, and may be matched to different operating conditions in the frequency converter system. Thus, depending on the operating conditions, optimum settings may be found for the electronic resistance in order to optimize the efficiency of the frequency converter system, with effective suppression of the undesirable system oscillations.

The electronic resistance (electronic circuit) allows any desired general complex impedance to be simulated, and the amplitude response and phase difference between the current and voltage can be chosen largely as required. Any energy present at the output of such an electronic resistance can be fed back into the intermediate circuit of the frequency converter system. Such an electronic resistance has high efficiency due to the feedback of the heat losses, which were previously emitted to the environment.

The electronic resistance can be coupled to the intermediate circuit of the frequency converter system locally and this can be done by means of a module that is compatible with the installation, for example between the input converter E and the inverter W.

The magnitude of this electronic resistance can be set in a suitable manner depending on the system configuration and load situation and can be adapted using suitable adaptation algorithms, which can also be designed to be self-learning, appropriately for the various operating states of the frequency converter system, in order to achieve the optimized damping of the undesirable resonant oscillation.

In general, what has been stated with regard to the embodiment of the damping element as a non-reactive resistor also applies to other embodiments of the damping element, in particular to the embodiments in the form of a PTC thermistor or an electronic resistance. With regard to the locations in the frequency converter system, the connecting elements for the latter may not only be connected to the input-side inductance or integrated in it, but may also be arranged as separate current transformers between the filter and the input side of the inverter. Furthermore, these embodiments of the damping element can be integrated in the inverter.

### DRAWINGS

The present invention is explained below in more detail with reference to exemplary embodiments shown in the Figures, in which:

FIG. 1 shows a block diagram of a frequency converter system having a three-phase motor connected to a converter with a voltage intermediate circuit and a regulated input converter as well as an input-side inductance;

FIG. 2 shows an equivalent circuit of the passive circuit formed by the arrangement of a converter system shown in FIG. 1, with regard to system oscillations;

FIG. 3 shows an outline illustration of a separate current transformer for transforming in the respective damping device between the filter F and the input converter E; and

FIG. 4 schematically shows a separate current transformer for transforming in the respective damping device between the input converter E and the inverter W.

### DETAILED DESCRIPTION OF THE INVENTION

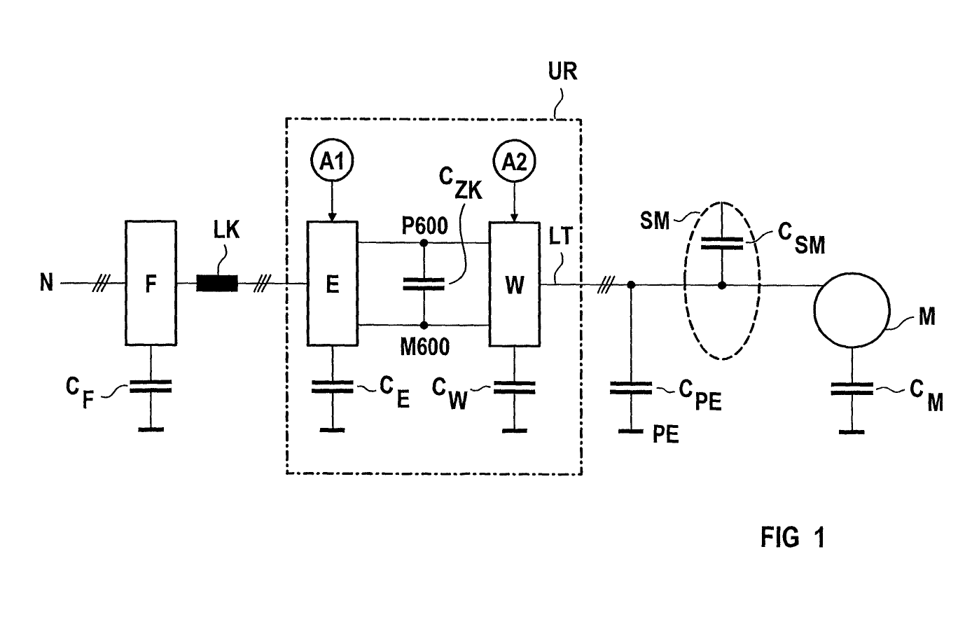

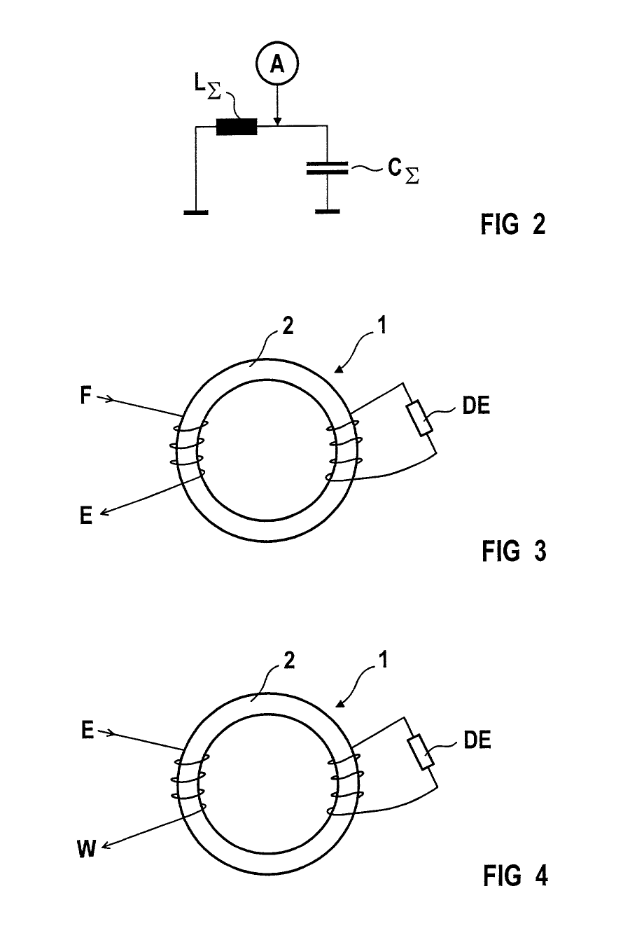

FIGS. 1 and 2 have already been discussed in considerable detail, and represent the schematic layout of the frequency converter system according to the invention. The connecting element described according to the invention for the damping element DE (general complex impedance) can be physically integrated in the mains system input inductor Lₖ as disclosed in SIEMENS AG, internal reference: 200017852. Alternatively, the damping element can be transformed in between the filter F and the input converter E, as shown in FIG. 1, via a separate transformer as the connecting element as shown in FIG. 3. Furthermore, the damping element DE can also be transformed into the converter UR between the input converter E and the inverter W, as shown in FIG. 1, by means of the connecting element shown in FIG. 4.

FIG. 3 and FIG. 4 show a current transformer 1 as the connecting element, which is in the form of a toroidal-core transformer 2, and by which the damping element DE is transformed into the frequency converter system. The damping element DE in this case is transformed in between the converter side of the filter F and the input converter E (FIG. 3), or between the input converter E and the inverter W (FIG. 4) in a frequency converter system as shown in FIG. 1. This results in particularly high efficiency with regard to oscillation suppression, and it can easily be retrofitted to existing frequency converter systems.

The connecting element can also transform in a first damping element DE between the converter side of the filter F and the input converter E, as well as a second damping element between the input converter E and the inverter W of a frequency converter system as shown in FIG. 1. This arrangement, while not shown, results in particularly effective damping.

The damping element DE may, for example, be in the form of a passive, solid-state impedance and, in particular, a non-reactive resistor R_{D} or a PTC thermistor (cold conductor), or in the form of an electronic resistance (electronic circuit), which is known per se.

We claim:

1. A frequency converter system comprising a filter, an input-side inductance, and a converter with an input converter and an inverter for operation of an electrical motor, further comprising a tuned circuit which is formed by at least one input- side inductance and parasitic distributed capacitances whereby undesirable resonant oscillations occur during operation of the frequency converter system, and wherein a damping device is provided for damping the tuned circuit.

2. The frequency converter system according to claim 1, where the damping device has a damping element and a connecting element for connection to the frequency converter system.

3. The frequency converter system according to claim 2, wherein the damping element is coupled to the frequency converter system via the connecting element acting as a transformer.

4. The frequency converter system according to claims 2 and 3, wherein the damping element is a passive, solid-state impedance.

5. The frequency converter system according to claim 4, wherein the passive, solid-state impedance is a non-reactive resistor for transformer coupling into the frequency converter system.

6. The frequency converter system according to claim 2, wherein the damping element is a passive variable impedance.

7. The frequency converter system according to claim 6, wherein the passive variable impedance is a PTC thermistor for transformer coupling into the frequency converter system.

8. The frequency converter system according to claim 2, wherein the damping device is an active variable impedance.

9. The frequency converter system according to claim 8, wherein the active variable impedance is an electronic resistance for transformer coupling into the frequency converter system.

10. The frequency converter system according to claim 2, wherein the connecting element is a separate current transformer for transformer coupling of the damping element into the frequency converter system.

11. The frequency converter system according to claims 2 and 10, wherein the connecting element is inserted into the frequency converter system between the filter and the input converter of the converter system.

12. The frequency converter system according to claim 2, wherein the connecting element is inserted into the frequency converter system between the input converter and the inverter of the converter.

13. The frequency converter system according to claim 1, wherein the input-side inductance is a mains system input inductor.
